(19) United States
(12) Patent Application Publication
(10) Pub. No.: US 2026/0271953 A1
(43) Pub. Date: Sep. 17, 2026

(54) AN OIL COMPOSITION AND A SPREAD COMPRISING THE SAME

(71) Applicant: Cargill, incorporated, Wayzata, MN (US)

(72) Inventors: Guifang CHANG, Shanghai, (CN); Saiyan Ding, Shanghai (CN); Yun GE, Shanghai (CN); Haiyong Shen, Shanghai (CN); Yaobin SI, Shanghai (CN)

(73) Assignee: Cargill, incorporated, Wayzata, MN (US)

(21) Appl. No.: 19/165,715

(22) PCT Filed: Mar. 21, 2023
(86) PCT No.: PCT/CN2023/082688

§ 371 Date: Sep. 16, 2025

(51) Int. Cl. A23D 7/005

(52) U.S. Cl. CPC A23D 7/0056

(57) ABSTRACT

An oil composition comprises liquid oil and from 3 wt. % to 40 wt. % of mono- and di-glycerides, based upon total weight of the oil composition. A spread comprises at least one food ingredient and the oil composition and a method for producing the spread. The use of oil composition for reducing the content of saturated fatty acid moieties in a spread comprising the oil composition.

### FIELD OF THE INVENTION

The present invention relates to an oil composition and a spread comprising the oil composition. In particular, the present invention relates to an oil composition including non-hydrogenated oil and fat with a low saturated fatty acid content.

### BACKGROUND

The food industry requires that oil and fats have good plasticity. For some special applications, such as spreads it requires a wide range of operating temperatures and fine crystallization texture.

WHO, along with CDC and FDA, urges people to limit their intake of saturated fats, as many experts have linked it with cardiovascular diseases. A diet high in saturated fats may lead to high cholesterol, which in turn may lead to atherosclerosis, coronary heart disease, and stroke. Saturated fat intake raises one's low density lipoprotein level and the low density lipoprotein is called “bad” cholesterol. WHO recommended that the fat intake is no more than 30% of total calories per day and the saturated fat intake is no more than 10% of total calories per day.

Most technologies focused on esterification processes or using hydrogenated oil to make spreads recently. It is difficult for the spreads to get soft at low temperature and have a low saturated fatty acid content simultaneously since no such technology was found in this area currently.

There are needs to provide oil compositions that have a lower saturated fatty acid content and spreads including the oil compositions which possess good mouthfeel without greasiness and has good spread ability. There are also needs to provide spreads that have a lower saturated fatty acid content and maintain a stable shape, good mouthfeel and fine texture.

### SUMMARY

To overcome the deficiencies as discussed above, the present invention provides an oil composition with a low saturated fatty acid content (e.g. 5-50 wt. % based on the total fatty acid profile) and free of trans fats. The present invention also provides a spread comprising the oil composition which can be used in a wide range of operating temperatures.

The invention provides an oil composition comprising liquid oil and from 3 wt. % to 40 wt. % of mono- and di-glycerides, based upon total weight of the oil composition.

The present invention provides a spread comprising at least one food ingredient and the oil composition discussed herein.

The present invention provides use of the oil composition discussed herein for reducing the content of saturated fatty acid moieties in a spread comprising the oil composition.

The present invention provides a method for preparing a spread discussed herein, comprising the following steps:
a. disperse a milk-based ingredient in water for preparing a water-phase
b. mix the water-phase of step a) with the oil composition discussed herein.

Other example embodiments are discussed herein.

### BRIEF DESCRIPTION OF DRAWINGS

FIG. 1 shows the crystallization form of Sample 2, Sample 3, Sample 7, Sample 8 and Sample 9 of oil compositions, respectively.

FIG. 2 shows the appearance of Spread A and Spread B in a bag (Left: Spread A; Right: Spread B).

FIG. 3 shows the appearance of Spread A and Spread B after being spread (Left: Spread A; Right: Spread B).

FIG. 4 shows the appearance of Spread A and Spread B after being spread on a tray starting at 4° C., and after maintaining at 30° C. for 30 minutes, 1 hour, 2 hours, 6 hours and 48 hours (Left: Spread A; Right: Spread B).

### DETAILED DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 1-about 100%” or “about 1-100%” should be interpreted to include not just about 1 to about 100%, but also the individual values (e g., 1, 2, 3, 4, 5 . . . 10, 11 . . . 98, 99, and 100%) and the sub-ranges (e.g., 2-99, 3-87, 10-90%, etc.) within the indicated range. The statement “about X to Y” has the same meaning as “about X to about Y,” unless indicated otherwise.

As used herein, the singular forms “a,” “an,” and “the” include plural referents unless the context clearly dictates otherwise. For example, reference to “a composition” encompasses a single composition as well as two or more compositions, and the like. It is understood that any term in the singular may include its plural counterpart and vice versa.

As used herein, the terms “for example, “for instance,” “such as,” “e.g.”, or “including” are meant to introduce examples that further clarify more general subject matter. Unless otherwise specified, these examples are provided only as an aid for understanding the applications illustrated in the present disclosure, and are not meant to be limiting in any fashion.

The term “about” as used herein can allow for a degree of variability in a value or range, for example, within 10%, within 9%, within 8%, within 7%, within 6%, within 5%, within 4%, within 3%, within 2%, or within 1% of a stated value or of a stated limit of a range, and includes the exact stated value or range.

### Oil Composition

The present invention provides an oil composition comprising liquid oil and from 3 wt. % to 40 wt. % of mono- and di-glycerides, based upon total weight of the oil composition.

In one aspect, the oil composition comprises from about 5 wt. % to about 38 wt. %, from about 7 wt. % to about 35 wt. %, from about 10 wt. % to about 30 wt. %, from about 15 wt. % to about 25 wt. % of mono- and di-glycerides, based upon total weight of the oil composition. In a preferred aspect, the oil composition comprises from about 15 wt. % to about 25 wt. % of mono- and di-glycerides, based upon total weight of the oil composition.

In one aspect, the liquid oil is non-hydrogenated. In one aspect, the liquid oil is selected from soybean oil, sunflower oil, canola oil, high oleic sunflower oil, high oleic canola oil, corn oil, or blends of two or more thereof. In a preferred aspect, the liquid oil is high oleic sunflower oil or canola oil. In another aspect, the liquid oil is high oleic canola oil.

In one aspect, the mono- and di-glycerides are based upon hydrogenated oil. In one aspect, the mono- and di-glycerides are based upon hydrogenated rapeseed oil, or hydrogenated palm oil stearin. In one aspect, the mono- and di-glycerides are based upon hydrogenated palm oil stearin and hydrogenated rapeseed oil. In one aspect, the oil composition does not include hydrogenated oil.

In one aspect, the mono- and di-glycerides comprise about 5 to about 99 wt. %, about 10 to about 90 wt. %, about 5 to about 80 wt. %, or about 15 to about 80 wt. % of mono-glycerides based upon the total weight of the mono- and di-glycerides. In a preferred aspect, the mono- and di-glycerides comprise about 5 to 30 wt. %, or about 10 to about 25 wt. % of mono-glycerides based upon the total weight of the mono- and di-glycerides.

In one aspect, the mono- and di-glycerides have a fatty acid profile comprising about 0.3 wt. % to about 50 wt. %, about 0.5 wt. % to about 40 wt. %, or about 0.7 wt. % to about 30 wt. % of C22 fatty acid based on the total fatty acid profile of the mono- and di-glycerides. In a preferred aspect, the mono- and di-glycerides have a fatty acid profile comprising about 15 wt. % to about 50 wt. %, or about 36 wt. % to about 48 wt. % of C22:0 fatty acid based on the total fatty acid profile of the mono- and di-glycerides.

In one aspect, the oil composition comprises about 70 to about 90 wt. % of the liquid oil and about 10 to about 30 wt. % of the mono- and di-glycerides, based upon the total weight of the oil composition. In another aspect, the oil composition comprises about 71 to about 84 wt. % of the liquid oil and about 16 to about 29 wt. % of the mono- and di-glycerides, based upon the total weight of the oil composition. In another aspect, the oil composition comprises about 75 to about 80 wt. % of the liquid oil and about 20 to about 25 wt. % of the mono- and di-glycerides, based upon the total weight of the oil composition.

N-Value gives the percentage of fat which is solid or in the crystallized form at a given temperature. For example, N20=35 indicates that 35% of the fat is in crystallised form at 20° C. (the amount of solids at that temperature). In one aspect, N10 value of the oil composition is about 5 to about 35, about 10.7 to about 31.4, about 16.0 to about 26.1, about 20.9 to about 31.4, about 20.9 to about 26.1, or about 26.1 to about 31.4. In one aspect, N20 value of the oil composition is about 4 to about 30, about 9.2 to about 29.1, about 14.1 to about 24.1, about 19 to about 29.1, about 19 to about 24.1, or about 24.1 to about 29.1. In one aspect, N25 value of the oil composition is about 4 to about 30, about 8.9 to about 28.3, about 13.8 to about 23.3, about 18.7 to about 28.3, about 18.7 to about 23.3, or about 23.3 to about 28.3. In one aspect, N30 value of the oil composition is about 3 to about 30, about 8.3 to about 27.8, about 13.3 to about 22.8, about 17.9 to about 27.8, about 17.9 to about 22.8, or about 22.8 to about 27.8. In one aspect, N35 value of the oil composition is about 2 to about 30, about 7.1 to about 27, about 11.8 to about 21.7, about 16.7 to about 27, about 16.7 to about 21.7, or about 21.7 to about 27.

In one aspect, (N10-N35)/N10 value of the oil composition is about 0.05 to about 1, about 0.1 to about 0.3, about 0.1 to about 0.2, or about 0.2 to about 0.3.

In one aspect, the saturated fatty acid content of the oil composition is about 10% to about 40%, about 18.0% to about 36.04%, about 22.5% to about 31.51%, about 26.98% to about 36.04%, about 26.98% to about 31.51%, or about 31.51% to about 36.04%.

The oil composition described herein has a lower saturated fatty acid content (such as lower than 50 wt % or 40 wt % or 35 wt %) and also has fine crystallization form under room temperature. In addition, it has been discovered that the solid fat content of the oil composition is substantially stable as temperature changes. In other words, the solid fat content of the oil composition changes little as the temperature changes.

### Spread

The present invention provides a spread comprising at least one food ingredient and the oil composition discussed herein.

In one aspect, the oil composition in the spread is present in an amount of from about 60 wt. % to about 80 wt. %, from about 65 wt. % to about 75 wt. %, from about 60 wt. % to about 70 wt. %, from about 70 wt. % to about 75 wt. %, from about 70 wt. % to about 80 wt. %, or from about 68 wt. % to about 72 wt. % based upon total weight of the spread.

In one aspect, the spread further comprises a milk-based ingredient as the at least one food ingredient. In another aspect, the milk-based ingredient is condensed milk. In one aspect, the milk-based ingredient is present in an amount of about 15 wt. % to about 25 wt. %, about 15 wt. % to about 20 wt. %, about 20 wt. % to about 25 wt. %, or about 18 wt. % to about 22 wt. % based upon total weight of the spread.

In one aspect, the spread further comprises water as the at least one food ingredient. In one aspect, water is present in an amount of about 5 wt. % to about 15 wt. %, about 5 wt. % to about 10 wt. %, about 10 wt. % to about 15 wt. %, or about 8 wt. % to about 12 wt. % based on the total weight of the spread.

In one aspect, the content of saturated fatty acids of the fatty acid profile in the spread is from about 5 wt. % to about 50 wt. %, from about 10 wt. % to about 45 wt. %, or from about 12 wt. % to about 40 wt. % based on the total fatty acid profile. In one aspect, the spread is free of trans fatty acid.

In one aspect, the solid fat content of the oil composition is flat, which does not vary significantly upon temperature changes, thus the spread is not hard at low temperature (e.g. 4° C.) and resist heat at high temperature (e.g. 30° C.), thereby allowing the different applications of the spread in a wide range of operating temperatures. In addition, the spread of the present invention provides good mouthfeel (e.g. soft and smooth texture) without greasiness and has good spread ability.

The present invention provides use of the oil composition discussed herein for reducing the content of saturated fatty acid moieties in a spread comprising the oil composition.

The present invention provides a method for preparing a spread discussed herein, comprising the following steps:
a. disperse a milk-based ingredient in water for preparing a water-phase
b. mix the water-phase of step a) with the oil composition discussed herein.

In one aspect, in step a) the milk-based ingredient is condensed milk. In one aspect, the water in step a) has a temperature of from about 45 to about 65° C., from about 45 to about 55° C., from about 45 to about 50° C., from about 50 to about 55° C., from about 50 to about 60° C., or from about 55 to about 65° C.

In one aspect, in step b) the oil composition and the water-phase are mixed at a temperature of from about 55° C. to about 80° C., from about 55° C. to about 75° C., from about 55° C. to about 70° C. or from about 55° C. to about 65° C. In one aspect, the temperature in step b) is at least about 5° C., at least about 10° C. or at least about 15° C. higher that the temperature of the water in step a).

In one aspect, the mixing in step b) is continued for at least about 10 minutes, for at least about 20 minutes, or at least about 30 minutes. In another aspect, the mixing in step b) is at a speed of about 650-800 rpm, about 700-800 rpm, or about 650-700 rpm.

In one aspect, the mixing in step b) is continued for at least about 10 minutes at a speed of about 650 rpm, for at least about 10 minutes at a speed of about 700 rpm, for at least about 10 minutes at a speed of about 800 rpm, for at least about 20 minutes at a speed of about 650 rpm, for at least about 20 minutes at a speed of about 700 rpm, for at least about 20 minutes at a speed of about 800 rpm, for at least about 30 minutes at a speed of about 650 rpm, for at least about 30 minutes at a speed of about 700 rpm, or for at least about 30 minutes at a speed of about 800 rpm.

In one aspect, step b) is continued at a temperature lower than about 55° C., lower than about 45° C., lower than about 25° C., lower than about 10° C., or lower than about 5° C. In one aspect, ice water is added to the mixture obtained in step b). In another aspect, the mixture obtained from step b) is stirred with ice water until the mixture is thickened.

In one aspect, the spread of the present invention can be easily produced under a simple blending process, in which special homogenization and texturization are not required. Therefore, the production cost of the spread can be reduced compared to other processes that involve esterification, homogenization and texturization.

### EXAMPLES

The following examples are presented to further illustrate and explain the present invention and should not be taken as limiting in any regard.

### Example 1

Oil compositions with different components have been prepared. The composition and the solid fat content of the oil composition samples have been summarized in below Table 1.

TABLE 1

| | Sample No. | | | | |
|---|---|---|---|---|---|
| | Sample 2 | Sample 3 | Sample 7 | Sample 8 | Sample 9 |
| | Oil composition | | | | |
| | 90% high | 85% high | 80% high | 75% high | 70% high |
| | oleic | oleic | oleic | oleic | oleic |
| | sunflower | sunflower | sunflower | sunflower | sunflower |
| | oil + 10% | oil + 15% | oil + 20% | oil + 25% | oil + 30% |
| | DMG1 | DMG1 | DMG1 | DMG1 | DMG1 |
| N10 | 10.7 | 16.0 | 20.9 | 26.1 | 31.4 |
| N20 | 9.2 | 14.1 | 19 | 24.1 | 29.1 |
| N25 | 8.9 | 13.8 | 18.7 | 23.3 | 28.3 |
| N30 | 8.3 | 13.3 | 17.9 | 22.8 | 27.8 |
| N35 | 7.1 | 11.8 | 16.7 | 21.7 | 27 |
| (N10 − | 0.3 | 0.3 | 0.2 | 0.2 | 0.1 |
| N35)/N10 | | | | | |
| Saturated | 18.0 | 22.5 | 26.98 | 31.51 | 36.04 |
| fatty acid | | | | | |

DMG 1 comprises 10 wt. %-25 wt. % of mono-glycerides and have a fatty acid profile comprising 36 wt. %-48 wt. % of C22:0 fatty acid based on the total fatty acid profile of the mono- and di-glycerides.

Sample 7 and Sample 8 have lower solid fat content slope determined by (N10-N35)/N10 which means the solid fat content changed little as temperature changed. The crystallization form of the oil composition samples are shown in FIG. 1. Sample 7 and Sample 8 also demonstrate fine crystallization state under room temperature.

### Example 2

The same experimental methods, conditions and components have been adopted as Example 1, except for high oleic sunflower oil being replaced with canola oil in Example 2.

The results show that samples “80% canola oil+20% DMG1” and “75% canola oil+25% DMG1” have solid fat content slope determined by (N10-N35)/N10 as low as samples 7-8 of Example 1 and exhibit fine crystallization state under room temperature as samples 7-8 of Example 1.

### Example 3

### Preparation of Spreads

Spreads A and B were prepared by the following procedures:
1. Water phase: disperse condensed milk in about 55° C. water;
2. Mix water and oil phase in about 70° C. and stir for about 30 minutes with about 800 rpm stir speed;
3. Continue stirring with ice water until thickened.

The compositions of Spread A and Spread B are listed in Table 2 below.

TABLE 2

| | | Content | | |
|---|---|---|---|---|
| | Oil | Oil | | Condensed |
| | composition | composition | water | milk |
| Spread A | 80% high | 70% | 10% | 20% |
| | oleic | | | |
| | sunflower | | | |
| | oil + 20% | | | |
| | DMG1 | | | |
| Spread B | 80% high | 70% | 10% | 20% |
| | oleic | | | |
| | sunflower | | | |
| | oil + 20% | | | |
| | DMG2 | | | |

DMG2 comprises 90 wt. %-100 wt. % of mono-glycerides and has a fatty acid profile comprising 0 wt. %-10 wt. % of C22:0 fatty acid based on the total fatty acid profile of the mono- and di-glycerides.

The appearance of Spread A and Spread B in a bag is shown in FIG. 2 (Left: Spread A; Right: Spread B). The appearance of Spread A and Spread B that have been spread on a tray is shown in FIG. 3 (Left: Spread A; Right: Spread B). It can be observed that Spread A exhibits a smoother texture compared to Spread B in both FIGS. 1 and 2. Grainy texture is observed in Spread B.

When the liquid oil (80% high oleic sunflower oil) in the Spread is replaced with 80% canola oil, there is no significant change in the texture for both Spread A and Spread B.

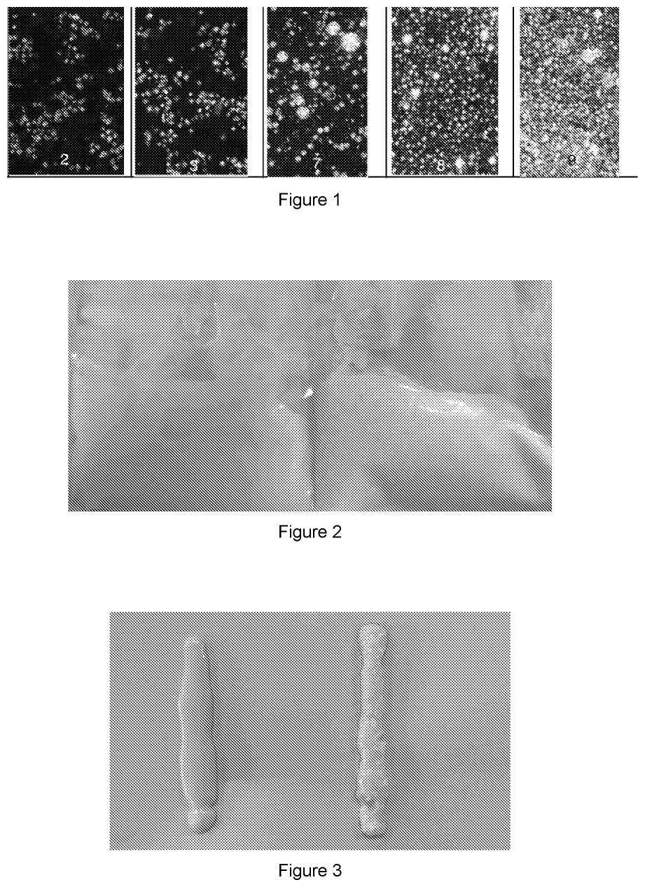

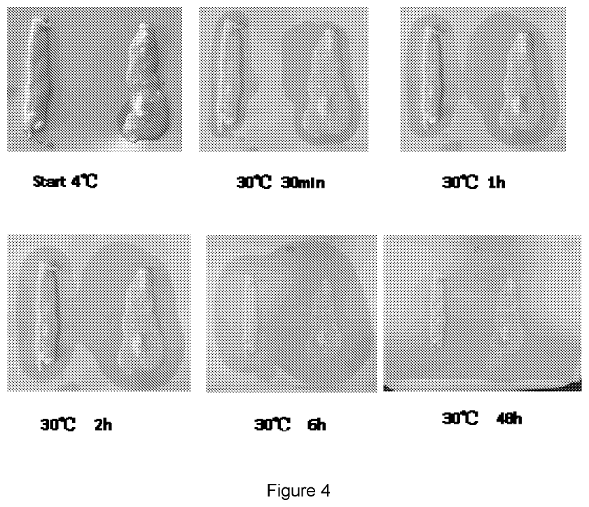

The appearance of Spread A and Spread B that have been spread on a tray starting at 4° C., and after maintaining at 30° C. for 30 minutes, 1 hours, 2 hours, 6 hours and 48 hours (Left: Spread A; Right: Spread B) is shown in FIG. 4. It can be observed that Spread A can maintain a stable shape and smooth texture even after 48 hours at 30° C., while Spread B exhibits grainy and coarse texture during the whole observation time. In addition, the moisture/liquid starts to ooze from Spread B starting at 4° C., while no moisture oozes from Spread A at 4° C. It can be seen that the soaking areas on the tray paper for Spread B are larger than those for Spread A from 30 minutes to 6 hours.

1. An oil composition comprising liquid oil and from 3 wt. % to 40 wt. % of mono- and di-glycerides, based upon total weight of the oil composition.

2. The oil composition according to claim 1, wherein the liquid oil is non-hydrogenated.

3. The oil composition according to claim 1, wherein the liquid oil is selected from soybean oil, sunflower oil, canola oil, high oleic sunflower oil, high oleic canola oil, corn oil, or blends of two or more thereof.

4. The oil composition according to claim 1, wherein the mono- and di-glycerides comprise 5 to 99 wt. % of mono-glycerides based upon the total weight of the mono- and di-glycerides.

5. The oil composition according to claim 1 wherein the mono- and di-glycerides have a fatty acid profile comprising 0.3 wt. % to 50 wt. % of C22:0 fatty acid based on the total fatty acid profile of the mono- and di-glycerides.

6. A spread comprising at least one food ingredient and the oil composition according to claim 1.

7. The spread according to claim 6, comprising the oil composition in an amount of from 60 wt. % to 80 wt. % based upon total weight of the spread.

8. The spread according to claim 6, wherein the spread is further comprising a milk-based ingredient as the at least one food ingredient.

9. The spread according to claim 6, wherein the spread is further comprising water as the at least one food ingredient.

10. The spread according to claim 6, wherein the content of saturated fatty acids of the fatty acid profile is from 5 wt. % to 50 wt. % based on the total fatty acid profile.

11. Use of the oil composition according to claim 1 for reducing the content of saturated fatty acid moieties in a spread comprising the oil composition.

12. The use according to claim 11, wherein the oil composition is present in an amount from 60 wt. % to 80 wt. % based upon total weight of the spread.

13. A method for preparing a spread according to claim 6, comprising the following steps:
a. disperse a milk-based ingredient in water for preparing a water-phase;
b. mix the water-phase of step a) with the oil composition according to any one of claims 1-4.

14. The method according to claim 13, wherein the temperature in step b) is at least 5° C. higher that the temperature of the water in step a).

15. The method according to claim 13, wherein the mixing in step b) is continued for at least 10 minutes at a speed of 650-800 rpm.
